(19) United States
(12) Patent Application Publication
(10) Pub. No.: US 2015/0204790 A1
(43) Pub. Date: Jul. 23, 2015

(54) STIMULATED RAMAN SCATTERING MEASUREMENT APPARATUS

(71) Applicant: CANON KABUSHIKI KAISHA, Tokyo (JP)

(72) Inventor: Yuki Yonetani, Utsunomiya-shi (JP)

(21) Appl. No.: 14/601,382

(22) Filed: Jan. 21, 2015

(30) Foreign Application Priority Data
Jan. 23, 2014 (JP) 2014-010272
Apr. 9, 2014 (JP) 2014-079818

(51) Int. Cl. G01N 21/65

(52) U.S. Cl. CPC G01N 21/65; G01N 2201/06113; G01N 2201/08

(57) ABSTRACT

The stimulated Raman scattering measurement apparatus includes a first light generator configured to produce a first light, a second light generator configured to produce a second light having an optical frequency different from that of the first light, an optical system to focus the first and second lights onto a sample, and a light detector configured to detect light whose intensity is modulated by stimulated Raman scattering generated by focusing the first and second lights onto the sample. The first light generator includes a Nd-doped fiber laser or a Nd-doped fiber optical amplifier, and the second light generator includes a Yb-doped fiber laser or a Yb-doped fiber optical amplifier.

### BACKGROUND OF THE INVENTION

1. Field of the Invention

The present invention relates to a stimulated Raman scattering measurement apparatus that performs measurements such as molecular vibration imaging, by utilizing stimulated Raman scattering (SRS) and that is suitable for observation apparatuses such as a microscope, an endoscope and the like.

2. Description of the Related Art

Utilizing coherent Raman scattering (CRS) enables observing a three-dimensional distribution of molecules contained in a biological object and observing the composition of the molecule. In particular, utilizing stimulated Raman scattering (SRS), which is categorized as a kind of the CRS, enables quantitative observation without spectral distortion. A measurement apparatus utilizing the SRS simultaneously focuses, onto a sample, two optical pulses (dual-wavelength optical pulses) whose wavelengths are mutually different to induce the SRS. When a difference between light frequencies of the dual-wavelength optical pulses matches with a vibration frequency of a molecule of the sample, the stimulated Raman scattering occurs at a light-condensing point of the optical pulses. Of the dual-wavelength optical pulses transmitted through the sample, an intensity of one optical pulse with a higher optical frequency, that is, with a shorter wavelength decreases (i.e., stimulated Raman loss is caused), and an intensity of the other optical pulse with a lower optical frequency, that is, with a longer wavelength increases (i.e., stimulated Raman gain is caused). Detecting the stimulated Raman loss and the stimulated Raman gain (hereinafter also collectively referred to as “an SRS signal”) enables performing molecular vibration imaging in which information on the vibration of the molecule of the sample is reflected.

In addition, changing the light frequencies of the dual-wavelength optical pulses enables detecting a dependency of the SRS signal on the light frequencies (Raman spectrum), which makes it possible to identify the tissue structure and composition of the sample. In other words, in order to observe various molecules and tissues, it is necessary to select the light frequencies (wavelengths) of light sources such that the vibration frequency of the molecule to be observed and the difference between the light frequencies of the dual-wavelength optical pulses match with each other.

In vibrations of molecules, particularly in a wave number range of approximately 650 to 1300 cm⁻¹, a substance-specific characteristic Raman spectrum can be acquired. This wave number range is generally called “a fingerprint region” and is used to identify a substance. Observation of the fingerprint region requires a light source apparatus capable of producing dual-wavelength optical pulses whose difference in light frequencies is included in a molecular vibration frequency range corresponding to the fingerprint region. Furthermore, in observation of a biological sample, it is necessary to use a near-infrared wavelength region (wavelength region of approximately 700 to 1000 nm) which is capable of being transmitted through biological objects with a high transmittance and is called a biological window.

International Patent Application No. WO2010/140614 and OPTICS LETTERS/Vol. 36, No. 13/pp. 2387-2389 (2011) disclose SRS measurement apparatuses capable of observing the fingerprint region. International Patent Application No. WO2010/140614 discloses an SRS measurement apparatus that synchronizes a titanium sapphire laser whose repetition frequency is 2:1 and a Yb-fiber laser with each other to simultaneously focus them onto a sample. In this apparatus, observation in the fingerprint region is enabled by adjusting an optical element constituted by, for example, a titanium sapphire crystal contained in the titanium sapphire laser to set an oscillation wavelength to near 900 nm. On the other hand, OPTICS LETTERS/Vol. 36, No. 13/pp. 2387-2389 (2011) discloses an SRS measurement apparatus that splits an optical pulse from one fiber laser into two optical pulses and converts the wavelength of one of the two optical pulses by using a photonic crystal fiber (that is, shifts the one optical pulse to a longer-wavelength side), thereby enabling the observation in the fingerprint region.

However, the SRS measurement apparatus disclosed in International Patent Application No. WO2010/140614 is generally large-sized and requires using a solid laser whose maintainability is low. On the other hand, the SRS measurement apparatus disclosed in OPTICS LETTERS/Vol. 36, No. 13/pp. 2387-2389 (2011) requires a low-efficiency wavelength conversion using soliton self-frequency shift. This may result in an insufficient intensity of the wavelength-converted light, or in an inconsistency between a wavelength band of the wavelength-converted light necessary to measure the fingerprint region and a gain band of a typical optical amplifier, which makes it difficult to perform optical amplification. This decreases an SN ratio in SRS observation in the fingerprint region, which makes it difficult to produce an image at high speed.

### SUMMARY OF THE INVENTION

The present invention provides an SRS measurement apparatus that is compact and capable of performing measurement in the fingerprint region.

The present invention provides as an aspect thereof a stimulated Raman scattering measurement apparatus including a first light generator configured to produce a first light, a second light generator configured to produce a second light having an optical frequency different from that of the first light, an optical system to focus the first and second lights onto a sample, and a light detector configured to detect light whose intensity is modulated by stimulated Raman scattering generated by focusing the first and second lights onto the sample. The first light generator includes a Nd-doped fiber laser or a Nd-doped fiber optical amplifier, and the second light generator includes a Yb-doped fiber laser or a Yb-doped fiber optical amplifier.

Further features of the present invention will become apparent from the following description of exemplary embodiments with reference to the attached drawings.

### BRIEF DESCRIPTION OF THE DRAWINGS

FIG. 1 is a block diagram illustrating a configuration of an SRS microscope that is Embodiment 1 of the present invention.

FIG. 2 is a block diagram illustrating a configuration of a pulse-timing detector in Embodiment 1.

FIG. 3 is a block diagram illustrating a configuration of a retarding optical path adder in Embodiment 1.

FIG. 4 is a block diagram illustrating a configuration of a Nd-fiber laser in Embodiment 1.

FIG. 5 is a block diagram illustrating another configuration of the ND-fiber laser in Embodiment 1.

FIG. 6 is a block diagram illustrating a configuration of an SRS microscope that is Embodiment 2 of the present invention.

FIG. 7 is a block diagram illustrating a configuration of an SRS microscope that is Embodiment 3 of the present invention.

FIG. 8 is a block diagram illustrating a configuration of an SRS microscope that is Embodiment 4 of the present invention.

FIG. 9 is a block diagram illustrating a configuration of an SRS microscope that is Embodiment 5 of the present invention.

FIG. 10 is a block diagram illustrating a configuration of an SRS microscope that is Embodiment 6 of the present invention.

### DESCRIPTION OF THE EMBODIMENTS

Exemplary embodiments of the present invention will be described below with reference to the attached drawings.

### Embodiment 1

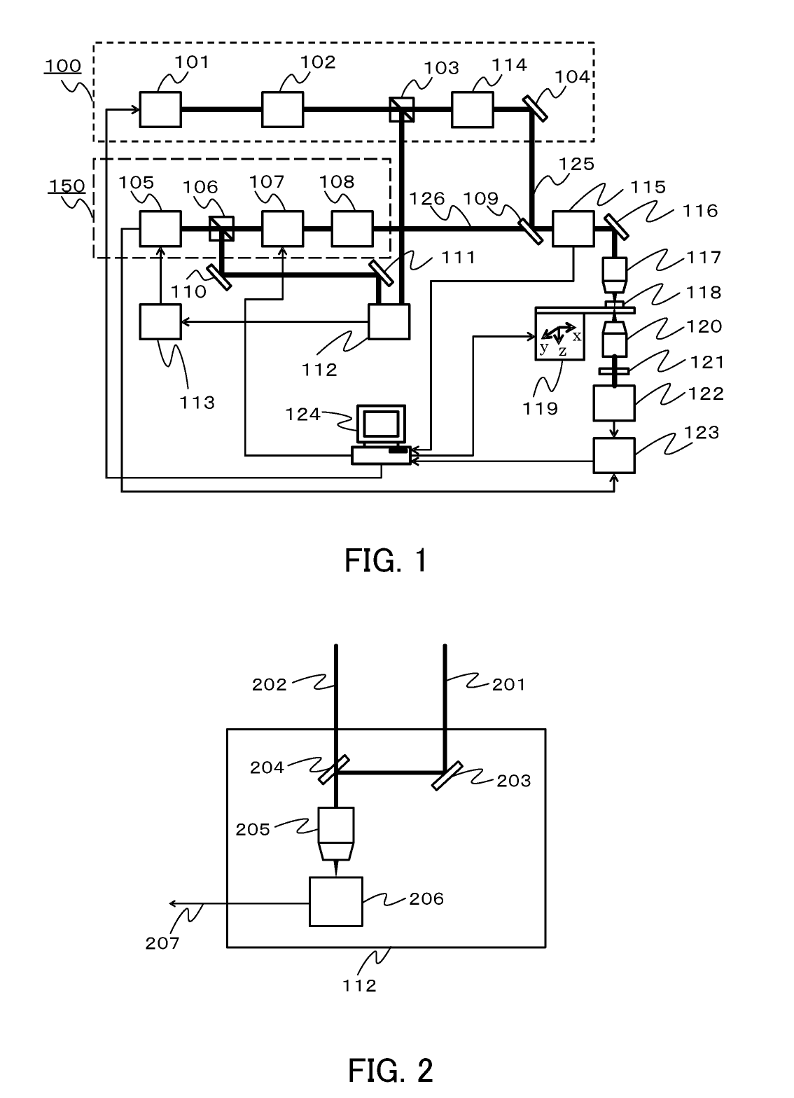

FIG. 1 illustrates a configuration of an SRS microscope as a stimulated Raman scattering measurement apparatus that is a first embodiment (Embodiment 1) of the present invention.

In FIG. 1, reference numeral 100 denotes a first light generator, and 101 a pulse oscillation Nd-doped fiber laser (hereinafter simply referred to as “a Nd-fiber laser”) used as a seed light source of the first light generator 100. Reference numeral 102 denotes a Nd-doped fiber optical amplifier (hereinafter simply referred to as “a Nd-fiber optical amplifier”) capable of optical (light) amplification in a wavelength band of a light from the Nd-fiber laser 101. Reference numerals 103 and 106 denote beam splitters, and 104, 110, 111 and 116 mirrors.

Reference numeral 150 denotes a second light generator, and 105 a pulse oscillation Yb-doped fiber laser (hereinafter simply referred to as “a Yb-fiber laser”) used as a seed light source of the second light generator 150. Reference numeral 107 denotes a tunable-wavelength selective filter corresponding to a wavelength filter and a tunable-wavelength selector, and 108 a Yb-doped fiber optical amplifier (hereinafter simply referred to as “a Yb-fiber optical amplifier”) capable of optical amplification in a wavelength band of a light from the Yb-fiber laser 105. Reference numeral 109 denotes a wave-combining dichroic mirror.

Reference numeral 112 denotes a pulse timing detector serving as a time difference detector, and 113 a pulse-synchronization controller serving as a synchronizer. Reference numeral 114 denotes a retarding optical path adder, and 115 a light deflector serving as a scanner.

Reference numerals 117 and 120 respectively denote a first objective lens and a second objective lens each being a collective lens. Reference numeral 118 denotes a sample, and 119 a sample driving stage serving as a sample mover. Reference numeral 121 denotes an undetected-light cutting filter. Reference numeral 122 denotes a light detector, and 123 a lock-in amplifier serving as a signal detector. Reference numeral 124 denotes a computer serving as a processor.

Reference numerals 125 and 126 respectively denote a first light and a second light each focused onto the sample 118. The first and second lights (optical pulses) are collectively referred to as “dual-wavelength optical pulses”. Bold lines and arrowed thin lines connecting elements in the figure respectively indicate optical paths and electrical wiring lines. It is desirable that the optical paths be each formed by a fiber to an extent possible.

In this embodiment, of the dual-wavelength optical pulses focused onto the sample 118, the light (optical pulse) from which the SRS is to be detected is defined as the first light, and the light (optical pulse) from which the SRS is not to be detected is defined as the second light. Moreover, in this embodiment, the first light generator 100, which produces the first light 125, is constituted by the Nd-fiber laser 101 serving as the seed light source, the Nd-fiber optical amplifier 102, the beam splitter 103, the retarding optical path adder 114 and the mirror 104. On the other hand, the second light generator 150, which produces the second light 126 having an optical frequency different from that of the first light 125, is constituted by the Yb-fiber laser 105, the beam splitter 106, the tunable-wavelength selective filter 107 and the Yb-fiber optical amplifier 108.

Although the first light generator 100 and the second light generator 150 respectively include all the constituent elements necessary to produce the first light 125 and the second light 126 each focused onto the sample 118, constituent elements of the first and second light generators 100 and 150 are not limited to those in this embodiment. That is, the first and second light generators 100 and 150 may be constituted, as appropriate, without unnecessary constituent elements depending on, for example, wavelengths and pulse widths of the first and second lights. Moreover, the first and second light generators 100 and 150 may include other additional constituent elements necessary to produce the first and second lights 125 and 126. This applies to other embodiments described later.

The Nd-fiber laser 101 is used as the seed light source in the first light generator 100 that emits the first light 125. According to “Nonlinear Fiber Optics” by G. P. Agrawal, a Nd fiber has three energy transitions at 920 nm, 1060 nm and 1350 nm and thereby can oscillate at wavelengths near the three wavelengths. The above “Nonlinear Fiber Optics” reports the oscillation of Nd fiber at 900 to 945 nm in a 920 nm band, that at 1070 to 1140 nm in a 1060 nm band and that at 1330 to 1340 nm in a 1350 nm band.

For this reason, in order to oscillate the Nd-fiber laser 101 at a desired wavelength, it is desirable to provide, inside a resonator, an optical element having a spectral transmittance or a spectral reflectance which enables transmission or reflection of only a desired wavelength light to be focused onto the sample 118 and which cuts off other wavelength lights.

The first light 125 is desirable to have a pulse width of approximately 1 to 10 ps in order to achieve high resolution of a Raman spectrum and to detect the SRS signal with high sensitivity. For the Nd-fiber laser oscillating at this pulse width, a resonator can be configured using a common mode-locking method that uses a non-linear polarization rotation method or a saturable absorber such as a semiconductor saturable absorber mirror. In order to stably oscillate the Nd-fiber laser even in environmental changes, the resonator is desirable to be a polarization-maintaining resonator.

The Nd-fiber optical amplifier 102 amplifies the light from the Nd-fiber laser 101 (hereinafter referred to as “a Nd-fiber laser light”). The Nd-fiber optical amplifier 102 may have a same configuration as that of a common rare-earth-doped fiber optical amplifier that amplifies an entering light by causing the entering light to pass through a rare-earth-doped gain fiber excited by an excitation light source.

The wavelength of the Nd-fiber laser light and a gain band of the Nd-fiber optical amplifier 102 can be made coincide with each other by using a Nd fiber as a gain fiber of the Nd-fiber optical amplifier 102, similarly to the resonator of the Nd-fiber laser 101. When the Nd-fiber laser 101 is configured as a polarization-maintaining fiber laser, also configuring the Nd-fiber optical amplifier 102 as a polarization-maintaining optical amplifier enables improving stability against changes of its polarization state due to environmental changes (that is, eliminating instability caused by the changes of the polarization state). Furthermore, configuring the Nd-fiber optical amplifier 102 as a multistage amplifier enables providing a higher power output.

The Yb-fiber laser 105 is used as the seed light source in the second light generator 150 that emits the second light 126. A Yb-fiber laser can typically oscillate in a wavelength range of approximately 1000 to 1100 nm. In this embodiment, filtering part of the light from the Yb-fiber laser 105 with the tunable-wavelength selective filter 107 enables varying the wavelength of the second light 126 focused onto the sample 118. For this reason, it is desirable to use, as the Yb-fiber laser 105, a laser oscillating in a wide wavelength band.

In addition, in this embodiment, in order to achieve high-speed lock-in detection aiming to maximize detection sensitivity, a resonator is configured such that a repetition frequency of the Yb-fiber laser 105 is half of a repetition frequency of the Nd-fiber laser 101. As well as the Nd-fiber laser 101, in order to stably oscillate the Yb-fiber laser 105 in environmental changes, it is desirable that the resonator be a polarization-maintaining resonator.

Although in this embodiment the second light generator 150 selects a wavelength, a system may be configured such that the first light generator 100 similarly selects the wavelength. In the SRS, generally, of the dual-wavelength optical pulses focused onto the sample, the shorter-wavelength light is called “a pump light”, and the longer-wavelength light is called “a Stokes light”. Also in this embodiment, the first light 125 is referred to as “a pump light”, and the second light 126 is referred to as “a Stokes light”.

Although this embodiment will describe the case where the repetition frequency of the Nd-fiber laser 101 is twice of that of the Yb-fiber laser 105, the repetition frequency of the Nd-fiber laser 101 may be an integral multiple, which is twice or more, of that of the Yb-fiber laser 105.

The tunable-wavelength selective filter 107 transmits (allows passage of), of the light from the Yb-fiber laser 105 (hereinafter referred to as “a Yb-fiber laser light”), only a light having a selected specific wavelength. As the tunable-wavelength selective filter 107, any one of filters may be used which are commonly used as tunable-wavelength selective filters such as a combination of a diffraction grating and a slit, an acoustic-optic tunable filter, a waveguide diffraction grating and a fiber Bragg grating (FBG). The tunable-wavelength selective filter 107 is desirable to select, since the second light 126 is also desirable to have a pulse width of 1 to 10 ps similarly to the first light 125, a wavelength width of approximately 0.1 to 1 nm, on a basis of a transform-limited pulse width.

The computer 124 controls the wavelength selected by the tunable-wavelength selective filter 107. For instance, when the combination of the diffraction grating and the slit is used as the tunable-wavelength selective filter 107, the computer 124 controls position and sweep speed of the slit provided on a movable stage. An intensity of the Yb-fiber laser light attenuated by the wavelength selection is amplified by the Yb-fiber optical amplifier 108 to a required intensity.

Moreover, configuring the Yb-fiber optical amplifier 108 as a multistage amplifier enables providing a higher power output. Furthermore, when the Yb-fiber laser 105 is configured as a polarization-maintaining fiber laser, also configuring the Yb-fiber optical amplifier 108 as a polarization-maintaining optical amplifier enables improving stability against changes of its polarization state due to environmental changes.

The beam splitter 103 separates, from the Nd-fiber laser light amplified by the Nd-fiber optical amplifier 102, a light for detecting pulse timings of the Nd-fiber laser light. The beam splitter 106 separates, from the Yb-fiber laser light from the Yb-fiber laser 105, a light for detecting pulse timings of the Yb-fiber laser light. As the beam splitters 103 and 106, any one of a polarization-dependent beam splitter, a polarization-independent beam splitter and a half mirror may be used. A split ratio of light intensity of each beam splitter is not required to be 1:1, and it is only necessary that each separated light from each beam splitter has a light intensity at which the pulse timing detector 112 can detect the pulse timings from each separated light. When the polarization-dependent beam splitter is used, inserting a λ/2-wave plate to a position preceding each beam splitter and rotating it enables continuously changing the split ratio of each beam splitter.

Alternatively, the beam splitters 103 and 106 may be respectively placed at a position preceding the Nd-fiber optical amplifier 102 and a position following the tunable-wavelength selective filter 107 or the Yb-fiber optical amplifier 108.

The pulse timing detector 112 detects a difference (relative time difference) between the pulse timings of the Nd-fiber and Yb-fiber laser lights. The difference between the pulse timings can be detected by coaxially introducing the Nd-fiber and Yb-fiber laser lights (optical pulses) to an objective lens to collect thereby the optical pulses on a photodiode and detecting an intensity of two-photon absorption between these optical pulses. In this case, as the photodiode, one having a low sensitivity to the wavelengths of the entering optical pulses and a high sensitivity to two-photon absorption occurring between the optical pulses is used. For example, a photodiode composed of a semiconductor made by GaAsP does not have a sensitivity to the Nd-fiber laser light whose wavelength is 920 nm and the Yb-fiber laser light whose wavelength is 1030 nm, but can detect, with a high sensitivity, the two-photon absorption occurring between these lights.

FIG. 2 illustrates an example configuration of the pulse timing detector 112. Reference numeral 201 denotes an optical path of the Nd-fiber laser light, and 202 an optical path of the Yb-fiber laser light. Reference numeral 203 denotes a mirror that reflects the Nd-fiber laser light. Reference numeral 204 denotes a dichroic mirror that transmits the Yb-fiber laser light and reflects the Nd-fiber laser light. The dichroic mirror 204 coaxially introduces the Nd-fiber and Yb-fiber laser lights to an objective lens 205. The Nd-fiber and Yb-fiber laser lights coaxially introduced to the objective lens 205 are collected thereby at a same position on a photodiode 206.

In the photodiode 206 on which the Nd-fiber and Yb-fiber laser lights are collected, two-photon absorption occurs depending on a time width in which the Nd-fiber and Yb-fiber laser lights overlap each other. Since the two-photon absorption for the Nd-fiber and Yb-fiber laser lights occurs more intensively as a time in which the Nd-fiber and Yb-fiber laser lights overlap each other becomes longer, it is possible to use the intensity of the two-photon absorption as an evaluation index for the difference between the timings (pulse timing difference) of the Nd-fiber and Yb-fiber laser lights.

Using such a pulse timing detector 112 enables efficiently exciting the SRS with respect to the Nd-fiber and Yb-fiber laser lights (dual-wavelength optical pulses), which can improve a sensitivity of the photodiode 206 to the SRS.

Reference numeral 207 denotes an electrical wiring line that sends an electrical signal corresponding to the pulse timing difference detected by the pulse timing detector 112 to the pulse-synchronization controller 113 of FIG. 1.

Referring to FIG. 1 again, description will be continued below. Upon receipt of the electrical signal from the pulse timing detector 112, the pulse synchronization controller 113 performs pulse synchronization control by changing, through adjustment of a length of the resonator of the Yb-fiber laser 105, the repetition frequency of the Yb-fiber laser 105 so as to eliminate (cancel) the above-mentioned pulse timing difference. The pulse synchronization control may be performed alternatively by adjusting a length of the resonator of the Nd-fiber laser 101 to change the repetition frequency of the Nd-fiber laser 101.

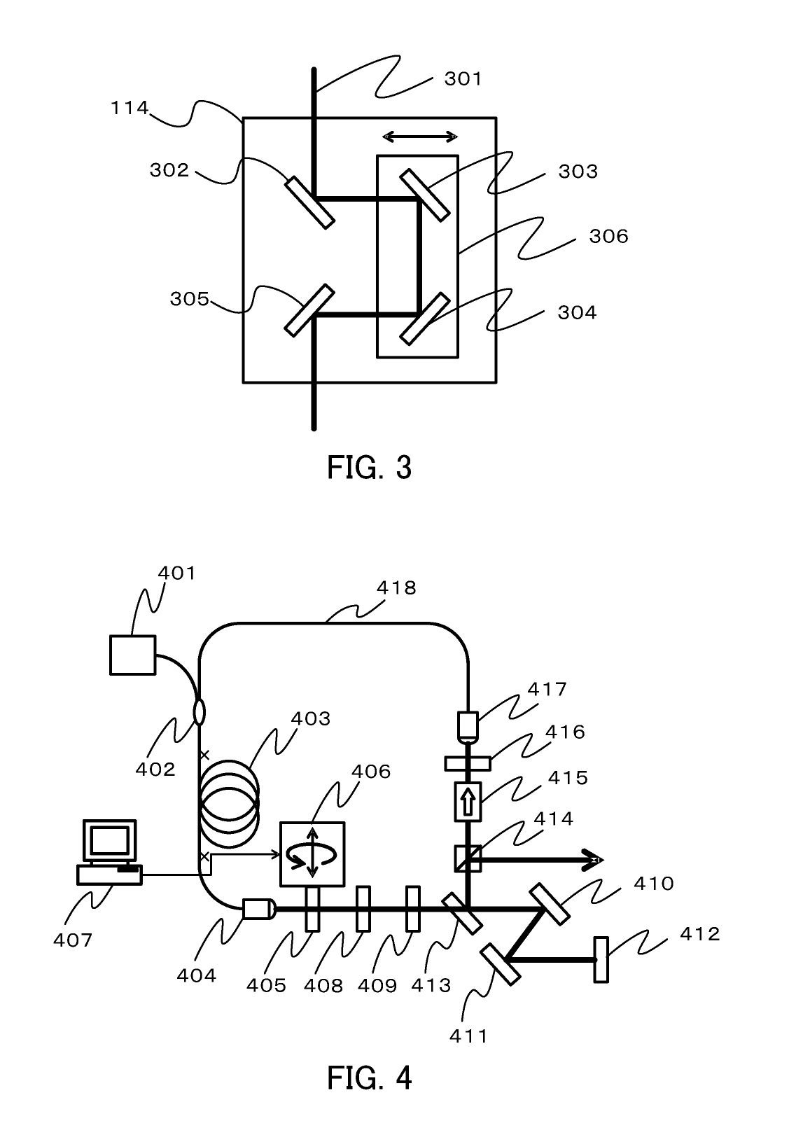

FIG. 3 illustrates an example configuration of the retarding optical path adder 114. Reference numeral 301 denotes an optical path of the Nd-fiber laser light. Reference numerals 302 to 305 denote mirrors. Reference numeral 306 denotes a driver that drives the mirrors 303 and 304 in a certain direction. Although in this embodiment a manually driven stage is used as the driver 306, an automatically driven stage is used when the driver 306 is driven in conjunction with the computer 124. Driving the driver 306 in the certain direction indicated by an arrow changes a length of the optical path 301 of the Nd-fiber laser light. The retarding optical path adder 114 respectively make a difference between optical path lengths of the Nd-fiber and Yb-fiber laser lights from the beam splitters 103 and 106 to the pulse timing detector 112 coincide with a difference between optical path lengths of the Nd-fiber and Yb-fiber laser lights from the beam splitter 103 and 106 to the sample 118.

As the retarding optical path adder 114, a fiber delay line or a commercially-available delay line may alternatively be used. In a case where the difference between the optical paths can be disregarded because of fiber-length adjustment of the fiber laser and the optical amplifier or of arrangement of the optical elements, the retarding optical path adder 114 is unnecessary.

Again, in FIG. 1, the first and second lights 125 and 126 are coaxially introduced to the light deflector 115 by adjusting positions of the mirror 104 and the dichroic mirror 109. The light deflector 115 deflects an exit angle of the first and second lights 125 and 126 coaxially introduced thereto in order to scan the sample 118 with a light-condensing point of the first and second lights 125 and 126. Although in this embodiment a galvanometer mirror is used as the light deflector 115, a resonant mirror or a polygon mirror may alternatively be used for high-speed scan. The microscope includes two galvanometer mirrors to perform two-dimensional scan. The two-dimensional scan of the sample 118 with the light-condensing point enables providing molecular vibration information of the sample 118 as an image.

The mirror 116 introduces the first and second lights 125 and 126 coaxially introduced to the dichroic mirror 109 through the light deflector 115 to the first objective lens 117. The first objective lens 117 collects the entering first and second lights 125 and 126 on the sample 118. The sample 118 is mounted on the sample driving stage 119. The sample driving stage 119 is driven in X, Y and Z directions to move the sample 118 to a scan region scanned with the light-condensing point.

The second objective lens 120 takes in a light (scattered light) from the sample 118 and collects it. In order to uniform a light quantity distribution on the sample 118 when the scan with the light-condensing point is performed by the light deflector 115 so as to prevent a marginal area of the image from being dark, paired relay lenses (scanning optical system) that makes a galvanometer mirror surface of the light deflector 115 conjugate with an entrance pupil plane of the first objective lens 117. In addition, in order to effectively take in the scattered light from the sample 118 to suppress artifact, a numerical aperture (NA) of the second objective lens 120 is desirable to be larger than that of the first objective lens 117.

The undetected-light cutting filter 121 is a band-pass filter which transmits only one of the first and second lights 125 and 126 that has a higher repetition frequency to cause the transmitted light to enter the light detector 122. The light detector 122 converts the entering optical pulse into an electrical signal. For efficient collecting the light to a light-receiving portion of the light detector 122, a lens may be inserted between the objective lens 120 and the light detector 122.

The lock-in amplifier 123 performs lock-in detection (synchronous detection) of an SRS signal (stimulated Raman scattering signal), from the electrical signal sent from the light detector 122, at a frequency identical to the repetition frequency of the second light 126. As a reference signal of the lock-in detection, an electrical signal from the Yb-fiber laser 105 is used. For instance, the reference signal can be produced by separating part of the Yb-fiber laser light and receiving it by a light receiver. To reduce noise generated during the lock-in detection, a band-pass filter allowing passage of only light in a repetition frequency band to be detected may be placed at a position preceding the lock-in amplifier 123.

The computer 124 reads out the SRS signal detected by the lock-in detection. The SRS signal contains information on the sample 118. The computer 124 performs signal processing on the SRS signal to produce SRS image data (two-dimensional image data) as images indicating vibration information of molecules in the sample 118 at respective wavelengths and displays these SRS image data on a display device. In producing the SRS image data, it is desirable to use a signal from the light deflector 115 as a trigger signal for starting data recording.

Alternatively, the computer 124 may apply a spectral analysis method such as main component analysis, independent component analysis or MCR-ALS (multivariate spectrum decomposition-alternating least squares) to each of the SRS image data for each wavelength and produces a pseudo-color image in which a pseudo color is added to a characteristic component to display the pseudo-color image on the display device.

Furthermore, the computer 124 can control the tunable-wavelength selective filter 107 to select a wavelength light transmitted through the filter 107. Moreover, the computer 124 can control the sample driving stage 119 to three-dimensionally set an observed portion in the sample 118.

Although this embodiment has described the case of performing the two-dimensional scan of the sample 118 with the light-condensing point by using the galvanometer mirror as the light deflector 115, the two-dimensional scan of the sample 118 with the light-condensing point may be performed by a combination of scan by a single-axis galvanometer mirror (line scan) and drive of the sample driving stage 119 in a direction orthogonal to a direction of the line scan. Alternatively, only the sample driving stage 119 may be driven in a two-dimensional plane. Moreover, when it is not necessary to produce the image containing the molecular vibration information, it is only necessary to perform Raman spectrum measurement at one point on the sample 118 without scanning of the sample 118 by the light deflector 115.

In this embodiment, a Raman spectral range (wave number range) in which the SRS measurement can be performed is calculated. When λ₁ represents a wavelength of the pump light, and λ₂ represents a wavelength of the Stokes light, a wave number difference k (Raman shift) between the pump and Stokes lights is expressed as expression (1). When wavelengths of the pump and Stokes lights are variable, max(λ₁) represents a maximum wavelength of the pump light, min(λ₁) represents a minimum wavelength of the pump light, max(λ₂) represents a maximum wavelength of the Stokes light and min(λ₂) represents a minimum wavelength of the Stokes light, a maximum wave number kₘₐₓ and a minimum wave number kₘᵢₙ in the wavenumber range in which the SRS measurement can be performed with the pump and Stokes lights are represented by expression (2).

In this embodiment, a wavelength of the Nd-fiber laser light, which is the pump light, is 920 nm, a wavelength of the Yb-fiber laser light, which is the Stokes light, is 1030 nm, and a wavelength-sweep width is ±15 nm. With this condition, from expression (2), a wavenumber range in which the SRS measurement can be performed is calculated as a range from 1017 cm⁻¹ up to 1300 cm⁻¹. This means that the SRS measurement can be performed in the fingerprint region.

$$\begin{matrix}k = \frac{1}{{λ}_{1}} - \frac{1}{{λ}_{2}} & ( 1 ) \\ {k}_{ma x} = \frac{1}{min ( {λ}_{1} )} - \frac{1}{max ( {λ}_{2} )} , {k}_{m i n} \frac{1}{max ( {λ}_{1} )} - \frac{1}{min ( {λ}_{2} )} & ( 2 )\end{matrix}$$

Moreover, the Nd-fiber laser 101 and the Yb-fiber laser 105 can respectively perform optical amplifications using the Nd-fiber optical amplifier 102 and the Yb-fiber optical amplifier 108. This enables providing a higher power output as compared with a case of using a wavelength conversion method with a low conversion efficiency, such as one using a highly non-linear fiber or one using a photonic crystal fiber, which enables improving an SRS detection sensitivity.

Although in this embodiment the Nd-fiber laser 101 is configured to have a repetition frequency twice of that of the Yb-fiber laser 105, the Nd-fiber laser 101 may have a repetition frequency identical to that of the Yb-fiber laser 105. In this case, a method is used which modulates any one of the intensity, wavelength and polarization state of one of the first and second lights 125 and 126 at an arbitrary repetition frequency according to an external input and performs the lock-in detection on the other non-modulated light at a modulation frequency.

Moreover, although in this embodiment the second light generator 150 selects the wavelength to measure the Raman spectrum, a Raman spectrum measurement method called a spectral focusing method described in OPTICS LETTERS/Vol. 36, No. 13/pp. 2387-2389 (2011) may alternatively be used.

The spectral focusing method focuses a pump light and a Stokes light onto a sample with making their chirp rates coincide with each other and relatively changes pulse timings of the pump and Stokes lights focused on the sample within their pulse width to change the Raman shift exciting the SRS and measure the Raman spectrum. Therefore, using the spectral focusing method requires a chirp rate adjuster that makes the chirp rates of the pump and Stokes lights coincide with each other and a variable time-difference adder that makes variable a difference between timings at which the pump and Stokes lights reach the sample. However, in this case, the tunable-wavelength selective filter can be omitted.

As the chirp rate adjuster, a glass block or paired diffraction gratings appropriately placed in the optical path to the objective lens 117 may be used.

The chirp rate C is a variation rate of an angular frequency defined by expression (3) where ω represents an angular frequency, and t represents a period of time.

$$C = \frac{d ω}{d t} \qquad ( 3 )$$

In the spectral focusing method, a higher degree of coincidence between the chirp rates of the pump and Stokes lights results in a higher Raman spectrum resolution.

It is desirable to configure the variable time-difference adder so as to be capable of adding the time difference in conjunction with the computer 124. This can be achieved by, for example, configuring the retarding optical path adder 114 of FIG. 3 such that the computer 124 controls a drive amount of the driver 306 as the automatically driven stage. The variable time-difference adder may be provided at any one of a place between the beam splitter 103 and the dichroic mirror 109 and a place between the beam splitter 106 and the dichroic mirror 109.

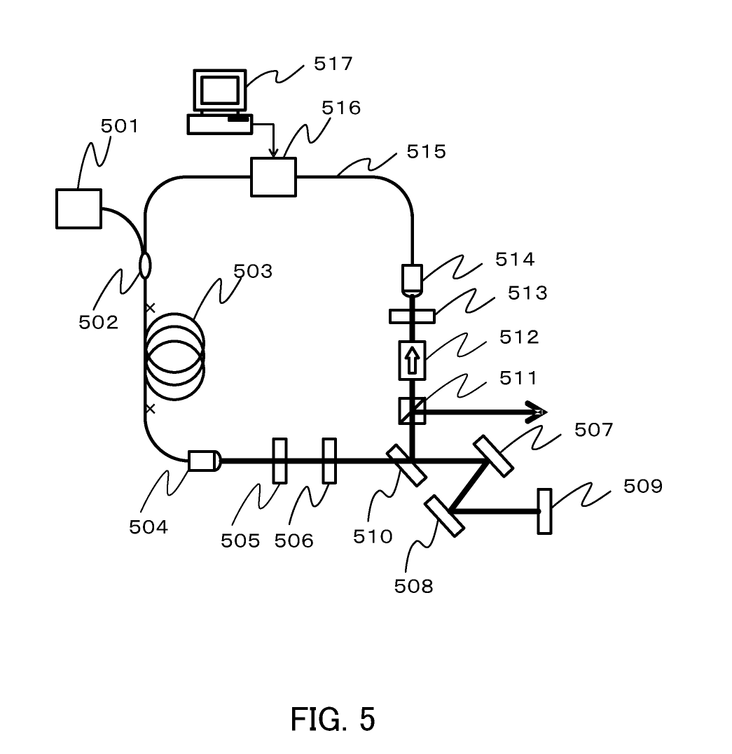

Next, referring to FIGS. 4 and 5, an example configuration of the Nd-fiber laser 101 of this embodiment will be described. This example configuration shows a case of increasing an observable Raman spectral range by appropriately switching the wavelength (oscillation wavelength) at which the Nd-fiber laser 101 oscillates. The Nd-fiber laser 101 includes one of resonators configured as illustrated in FIGS. 4 and 5.

In FIG. 4, reference numeral 401 denotes a laser diode, and 402 a wavelength division multiplexing coupler. Reference numeral 403 denotes a Nd-doped fiber (hereinafter referred to as “a Nd fiber”). Reference numerals 404 and 417 denote fiber collimators, and 405 a wavelength selective filter. Reference numeral 406 denotes a filter driving stage, and 407 a computer. Reference numerals 408 and 416 denote λ/4-wave plates, 409 a λ/2-wave plate, and 410 and 411 paired diffraction gratings. Reference numerals 412 and 413 denote mirrors, and 414 a beam splitter. Reference numeral 415 denotes an optical isolator, and 418 a single-mode fiber.

The configuration of the resonator illustrated in FIG. 4 is a configuration that uses the above-mentioned mode-locking method utilizing the non-linear polarization rotation. The non-linear polarization rotation is a phenomenon in which a polarization state of light varies depending on a light intensity in a fiber. Adjusting angles of wave plates located in an optical path such that transmittance thereof only for a light component with a high light intensity causes only that light component to remain, and amplifying the remaining light component produces an optical pulse.

The laser diode 401 excites the Nd-fiber 403 through the wavelength-multiplexing coupler 402. The laser diode 401 is desirable to emit an output light whose wavelength is near 808 nm which is suitable for exciting a 920 nm band. A light emitted from the excited Nd-fiber 403 is converted by the fiber collimator 404 into a collimated light and then output to a space.

The light output to the space enters the wavelength selective filter 405 where only a partial light thereof with a wavelength corresponding to part of a gain range of the Nd-fiber 403 is transmitted therethrough and another partial light with other wavelengths are cut by the filter 405. The wavelength selective filter 405 corresponds to a suppressor that suppresses a gain for wavelengths different from that of the light focused onto the sample. The wavelength selective filter 405 is constituted by a dielectric multi-layer film and capable of changing a wavelength of light transmitted therethrough by changing an incident angle of the light.

The wavelength selective filter 405 is mounted on the filter driving stage 406 capable of translation and rotation. The translation of the filter-driving stage 406 switches insertion and retraction with respect to an optical path between the fiber collimator 404 and the λ/4-wave plate 408, and the rotation of the filter driving stage 406 changes an angle of the wavelength selective filter 405 with respect to the laser light. Since it is only necessary that the oscillation wavelength is switched to several wavelengths, multiple wavelength selective filters 405 may be provided and selectively inserted into the optical path.

The computer 407 controls the filter driving stage 406.

The wave plates 408, 409 and 416 are respectively adjusted in their angles such that power of a light reflected by the beam splitter 414 becomes maximum. The paired diffraction grating 410 and 411 compensate for dispersion occurring inside the resonator, particularly in a fiber portion.

The mirror 412 tilts its optical axis such that the light enters a reflective surface of the mirror 413 disposed slightly below an entrance optical axis to the mirror 412. The beam splitter 414 reflects part of the entering light and causes it to exit to an outside of the resonator as a laser output. The optical isolator 415 limits a propagation direction of a light transmitted through the beam splitter 414. The fiber collimator 417 couples the light propagating in space to the fiber.

The single-mode fiber 418 reintroduces the light from the fiber collimator 417 to the excited Nd-fiber 403. The light propagating in the resonator repeats the propagation in the entire resonator, and thereby only its part having a high light intensity is amplified to be pulsed. If a loss in the resonator is large and thus self-starting oscillation is difficult, it is desirable to provide an external modulator such as a phase modulator in the resonator and input an alternating current signal with a frequency identical to the repetition frequency.

In this embodiment, as the wavelength selective filter 405, two filters respectively transmit a light with a wavelength of 920 nm and a light with a wavelength of 945 nm may be switchably used. The use of these two filters enables switching (changing) the oscillation wavelength of the Nd-fiber laser 101 between 920 nm and 945 nm. An oscillation wavelength changer that changes the oscillation wavelength of the Nd-fiber laser 101 is thus configured.

In this embodiment, the wavelength of the Nd-fiber laser light, which is the pump light, is 920 nm or 945 nm, the wavelength of the Yb-fiber laser light, which is the Stokes light, is 1030 nm, and a wavelength sweep width is ±15 nm. With this condition, from above-described expression (2), the observable Raman spectrum is up to 1017 to 1300 cm⁻¹ or 730 to 1013 cm⁻¹. This setting makes it possible to acquire the Raman spectrum in almost whole of the fingerprint region, which results in improvement in substance identification capability by the SRS microscope.

The oscillation wavelength can be sequentially changed by rotating the wavelength selective filter 405 in the 920 nm band. In addition, switching between three or more oscillation wavelengths can be made by adding another wavelength selective filter 405.

Moreover, the switching of the oscillation wavelength may be made in a fiber optical path illustrated in FIG. 5. Constituent elements denoted by reference numerals 501 to 504 and 505 to 515 are identical to those denoted by reference numerals 401 to 404 and 408 to 418 in FIG. 4, and therefore description thereof are omitted.

Reference numeral 516 denotes a fiber-connected tunable-wavelength filter module, and 517 a wavelength switch controlling computer. The fiber-connected tunable-wavelength filter module 516 is a device constituted by a fiber connector, a fiber collimator and a wavelength selective filter. This device includes, for example, fiber connectors at its both ends, introduces a light from an entrance-side fiber collimator to the wavelength selective filter and causes the light transmitted through the wavelength selective filter to enter an exit-side fiber collimator and to propagate again in a fiber.

The fiber-connected tunable-wavelength filter module 516 includes a micrometer whose rotation angle is adjustable, which enables, by changing an angle of the wavelength selective filter provided inside the fiber-connected tunable-wavelength filter module 516, selecting a transmissive wavelength through the filter. If a relation between the angle of the wavelength selective filter in the fiber-connected tunable-wavelength filter module 516 and the transmissive wavelength is known, the angle can be changed manually or according to a control signal sent from the computer 517, depending on the oscillation wavelength. Thus, another oscillation wavelength changer is thus configured.

In addition, the oscillation wavelength changer is not limited to those illustrated in FIGS. 4 and 5, and any element or device may be used as long as a filter capable of arbitrarily switching the transmissive wavelength in the resonator is constituted by using it.

Since, of all the oscillation wavelength bands of the Nd fiber, an oscillation wavelength band where a largest gain is provided is the 1060 nm band, a Nd-fiber laser normally configured logically oscillates in the 1060 nm band. Therefore, when a Nd-fiber laser configured by using a conventionally known method is used as a light source of the stimulated Raman measurement apparatus, only a limited part of the fingerprint region can be measured. In contrast, this embodiment employs, in consideration of oscillation characteristics of the Nd-fiber laser, a configuration that makes oscillation in a 900 nm band efficient by using the suppressor and the oscillation wavelength changer. That is, this embodiment performs flexible wavelength switching in the 900 nm band by providing inside a light source an element that suppresses oscillation in an undesired wavelength band, and by providing an element or a configuration that switches a transmissive wavelength in the resonator. Conventionally known fiber lasers (such as a Pr-fiber laser, an Er-fiber laser and a Tm-fiber laser) each have no wavelength band in its oscillation wavelength band where the fingerprint region can be measured when being combined with the Yb-fiber laser. For this reason, in the case of using such a conventionally known fiber laser, an issue that the suppression or change of the oscillation wavelength in the oscillation wavelength band is required cannot occur.

This embodiment enables, by using the Nd-fiber laser oscillated in the 900 nm band, focusing a light whose wavelength is suitable for biological objects onto the sample (biological object sample) without using a wavelength converter and enables performing stimulated Raman scattering measurement in the fingerprint region by using the combination of the Nd-fiber laser and the Yb-fiber laser. In addition, since the Nd-fiber optical amplifier can directly perform optical amplification, it is possible to sufficiently amplify a focused light power without a light loss due to wavelength conversion, which enables a high-sensitivity measurement.

Moreover, this embodiment enables, by utilizing a wide oscillation wavelength band width of the Nd-fiber laser and thereby eliminating a necessity of alignment or temperature control when changing the oscillation wavelength, performing spectral measurement at high speed in a wide range of the fingerprint region. As the conventionally known fiber lasers, the Pr-fiber laser can oscillate in a 1280 nm band, the Er-fiber laser can oscillate in a 1560 nm band, and the Tm-fiber laser can oscillate in a 2000 nm band. These wavelength bands are not suitable for observation of the biological objects, so that a configuration is required which performs conversion of their wavelength into a wavelength near the biological window by using a wavelength converter such as a second-harmonic generator. In a case where the wavelength converter is used, when the wavelength before the wavelength conversion is changed, optimization (alignment, temperature control and the like) of the wavelength converter is essential, and the wavelength conversion cannot be performed immediately after the wavelength before the wavelength conversion is changed. Therefore, it is impossible to perform wavelength switching at high speed, that is, to perform high-speed spectral measurement. Moreover, it is difficult to amplify a light after its wavelength is converted, so that measurement sensitivity is decreased. As a result, high-speed and high-sensitivity measurement becomes impossible to be performed or optical amplification that can compensate for the decrease of the measurement sensitivity is necessary before the wavelength conversion, which leads to an increase in cost and size of the apparatus.

In addition, since this embodiment uses fiber lasers that are compact, require less maintenance and do not cause light power loss due to wavelength conversion, which can realize an SRS microscope capable of stably performing high-speed and high-sensitivity measurement with a compact configuration.

Moreover, this embodiment uses the Nd-fiber laser and the Yb-fiber laser that are easily obtained, which makes it possible to easily manufacture the SRS measurement apparatus and the SRS microscope.

### Embodiment 2

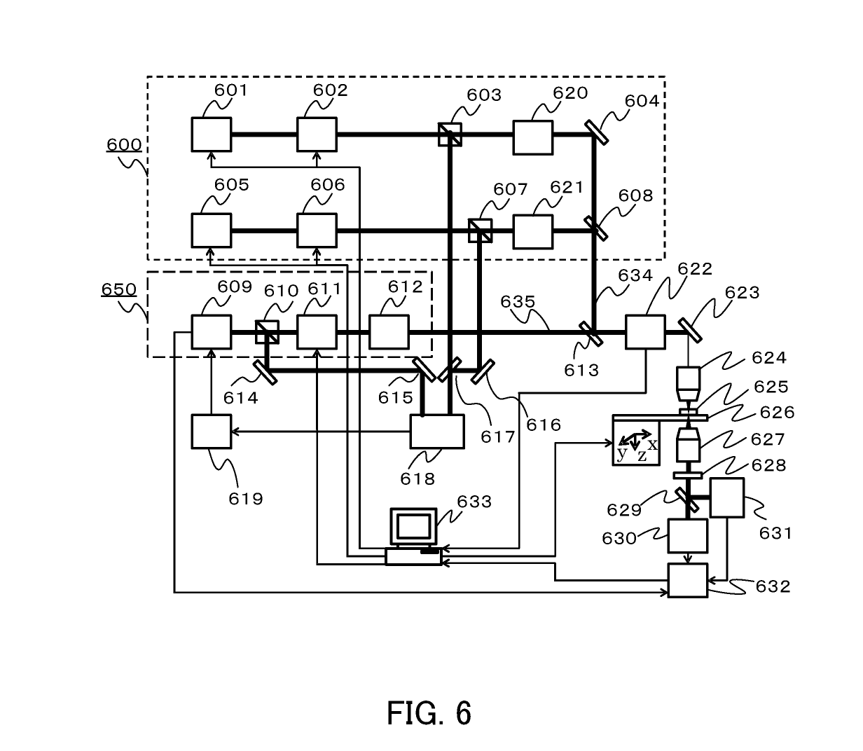

Next, referring to FIG. 6, a second embodiment (Embodiment 2) of the present invention will be described. This embodiment provides an SRS microscope whose Raman spectrum acquisition range is further increased by using multiple Nd-fiber lasers whose oscillation wavelength bands are mutually different. The SRS microscope of Embodiment 2 includes an optical system and a measurement system whose configurations are approximately same as those of Embodiment 1 and is different from the SRS microscope of Embodiment 1 in including another Nd-fiber laser having a different oscillation wavelength band.

FIG. 6 illustrates a configuration of the SRS microscope of this embodiment. Reference numeral 600 denotes a first light generator, and 601 a first Nd-fiber laser, which is a seed light source of the first light generator 600. Reference numeral 602 denotes a first Nd-fiber optical amplifier that amplifies a light (Nd-fiber laser light) from the first Nd-fiber laser 601. Reference numerals 603, 607 and 610 denote beam splitters, and 604, 614, 615, 616 and 623 mirrors. Reference numerals 608, 613, 617 and 629 denote dichroic mirrors.

Reference numeral 605 denotes a second Nd-fiber laser, which is another seed light source of the first light generator 600. The second Nd-fiber laser 605 oscillates in a wavelength band different from that of the first Nd-fiber laser 601. Reference numeral 606 denotes a second Nd-fiber optical amplifier that amplifies a light (Nd-fiber laser light) from the second Nd-fiber laser 605. Reference numeral 625 denotes a sample. Reference numerals 634 and 635 respectively denote a first light and a second light that are focused onto the sample 625.

Reference numeral 650 denotes a second light generator, and 609 a Yb-fiber laser, which is a seed light source of the second light generator 650. Reference numeral 611 denotes a tunable-wavelength selective filter, and 612 a Yb-fiber optical amplifier that amplifies a light (Yb-fiber laser light) from the Yb-fiber laser 609. Reference numeral 618 denotes a pulse timing detector, and 619 a pulse synchronization controller. Reference numerals 620 and 621 denote retarding optical path adders. Reference numeral 622 denotes a light deflector. Reference numerals 624 and 627 respectively denote a first objective lens and a second objective lens. Reference numeral 626 denotes a sample driving stage. Reference numeral 628 denotes an undetected-light cutting filter. Reference numerals 630 and 631 denote light detectors. Reference numeral 632 denotes a lock-in amplifier (lock-in detector), and 633 a computer.

Bold lines and arrowed thin lines connecting elements in the figure respectively indicate optical paths and electrical wiring lines. It is desirable that the optical paths be each formed by a fiber to an extent possible.

Constituent elements denoted by reference numerals 601 to 604 in FIG. 6 are identical to those denoted by reference numerals 101 to 104 in FIG. 1. The second Nd-fiber laser 605 utilizes a gain of its Nd fiber in a 1060 nm band and oscillates in a wavelength range from approximately 1060 to 1120 nm.

The dichroic mirrors 608 and 613 introduce the Nd-fiber laser light from the first and second Nd-fiber lasers 601 and 605 coaxially with the Yb-fiber laser light from the Yb-fiber laser 609 to the light deflector 622. Although in this embodiment the Nd-fiber laser light used for pulse timing detection and focused on to the sample is switched by turning on and off of powers of the Nd-fiber optical amplifiers 602 and 606, the Nd-fiber laser light used for them may be switched by turning on and off of powers of the first and second Nd-fiber lasers 601 and 605. Alternatively, the Nd-fiber laser light used for them may be switched by a switch mechanism provided to each of the dichroic mirrors 608 and 617.

Constituent elements denoted by reference numerals 609 to 613 in FIG. 6 are identical to those denoted by reference numerals 105 to 109 in FIG. 1. The beam splitters 603 and 607 respectively separate lights necessary for pulse timing detection from the Nd-fiber laser light from the first or second Nd-fiber laser 601 or 605 and the Yb-fiber laser light from the Yb-fiber laser 609, similarly to the beam splitters 103 and 106 of FIG. 1. The separated lights enter the pulse timing detector 618.

The pulse timing detector 618 detects a pulse timing difference between the Nd-fiber laser light focused onto the sample 625 from the first or second Nd-fiber laser 601 or 605 and the Yb-fiber laser light from the Yb-fiber laser 609.

The pulse timing detector 618 outputs an electrical signal corresponding to the pulse timing difference to the pulse synchronization controller 619. The pulse synchronization controller 619 controls, on a basis of the input signal, a length of a resonator in the Yb-fiber laser 609 to perform synchronization control.

The retarding optical path adders 620 and 621 make a difference between optical path lengths of the Nd-fiber and Yb-fiber laser lights (first and second lights 634 and 635) on the pulse timing detector 618 coincide with a difference between optical path lengths thereof on the sample 625, similarly to the retarding optical path adder 114 of FIG. 1.

Constituent elements denoted by reference numerals 622 to 628 in FIG. 6 are identical to those denoted by reference numerals 115 to 121 in FIG. 1. The splitting dichroic mirror 629 transmits one of the lights coaxially entering from the first and second Nd-fiber lasers 601 and 605 and reflects the other depending on their wavelengths. The lights transmitted therethrough or reflected thereby are received by the light detectors 630 and 631 corresponding to their wavelengths. The light detectors 630 and 631 output electrical signals to the lock-in amplifier 632. The lock-in amplifier 632 detects an SRS signal by lock-in detection. The computer 633 performs, by using the SRS signal, data recording, signal processing, image producing, analysis and image display.

This embodiment uses the two Nd-fiber lasers whose oscillation wavelength bands are mutually different and further switches the oscillation wavelength of each Nd-fiber laser. Specifically, this embodiment switches the oscillation wavelength of the first Nd-fiber laser 601 between 920 nm and 945 nm and switches the oscillation wavelength of the second Nd-fiber laser 605 between 1090 nm and 1120 nm.

In this embodiment, depending on the wavelength of the first light 634, the first light 634 serves as any one of a pump light and a Stokes light. Specifically, in a case where the wavelength of the second light 635 is 1030 nm and in the first light generator 600 the first Nd-fiber optical amplifier 602 is turned on and the second Nd-fiber optical amplifier 606 is turned off, the wavelength of the first light 634 is 920 nm or 945 nm. In this case, the first light 634 serves as the pump light, and the second light 635 serves as the Stokes light. Conversely, in a case where the wavelength of the second light 635 is 1030 nm and in the first light generator 600 the first Nd-fiber optical amplifier 602 is turned off and the second Nd-fiber optical amplifier 606 is turned on in the first light generator 600, the wavelength of the first light 634 is 1090 nm or 1120 nm. In this case, the first light 634 serves as the Stokes light, and the second light 635 serves as the pump light.

In such a configuration, a Raman spectral range increased by addition of the second Nd-fiber laser 605 is as described below. When a wavelength λ₁ of the Yb-fiber laser light is 1030 nm, a wavelength-sweep width is ±15 nm, and a wavelength λ₂ is 1090 nm or 1120 nm, the Raman spectral range calculated from expression (2) is a wave number range from 395 to 678 cm⁻¹ or from 641 to 923 cm⁻¹. This makes it possible to perform measurement in a lower wave number range of the fingerprint region than in Embodiment 1.

As described above, providing the multiple Nd-fiber lasers makes it possible to detect the SRS in the lower wave number range of the fingerprint region. This enables acquiring the Raman spectrum in the entire fingerprint region, which further improves a substance identification capability of the SRS microscope.

Although this embodiment performs wavelength selection by the tunable-wavelength selective filter 611 in the second light generator 650, similar wavelength selection may be performed in the first light generator 600.

This embodiment enables, by using a light source including the multiple Nd-fiber lasers that oscillate in the mutually different wavelength bands, realizing the SRS microscope capable of detecting the SRS in the entire fingerprint region.

### Embodiment 3

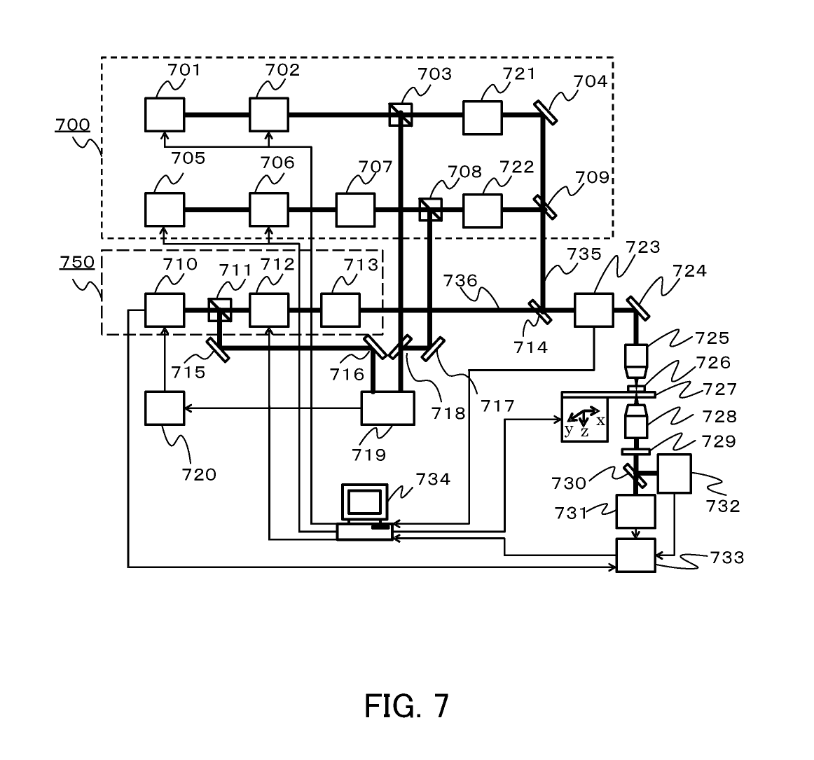

Next, referring to FIG. 7, a third embodiment (Embodiment 3) of the present invention will be described. This embodiment adds, as a first fiber laser, an Er-fiber laser whose oscillation wavelength band is different from that of the Nd-fiber laser, which enables further increasing the Raman spectrum acquisition range.

FIG. 7 illustrates a configuration of an SRS microscope of this embodiment. The SRS microscope of this embodiment includes an optical system and a measurement system that are approximately same as those of Embodiment 2 and is different from the SRS microscope of Embodiment 2 in including the Er-fiber laser and a second-harmonic generator instead of the second Nd-fiber laser.

Constituent elements denoted by reference numerals 701 to 704 and 708 to 736 are identical to those denoted by reference numerals 601 to 604 and 607 to 635 in FIG. 5.

Reference numeral 700 denotes a first light generator, and 705 a pulse oscillation Er-doped fiber laser (hereinafter simply referred to as “an Er-fiber laser”), which is a seed light source different from the Nd-fiber laser 701. Reference numeral 706 denotes an Er-doped fiber optical amplifier (hereinafter simply referred to as “an Er fiber optical amplifier”) capable of optical amplification in a wavelength band of a light (Er-fiber laser light) from the Er-fiber laser 705. Reference numeral 707 denotes the second-harmonic generator.

Reference numeral 750 denotes a second light generator. A Yb-fiber laser 710 oscillates a light (Yb-fiber laser light) whose wavelength is 1030 nm. Reference numeral 712 denotes a Yb-fiber optical amplifier 712 that performs optical amplification in an oscillation wavelength band of the Yb-fiber laser 710. The second-harmonic generator 707 emits a second harmonic of the entering Er-fiber laser light. Since the Er-fiber laser 705 has a wavelength of 1580 nm, an emission wavelength of the second-harmonic generator 707 is 790 nm. As the second-harmonic generator 707, a periodically poled LiNbO₃ crystal (PPLN) can be used. A second-harmonic generator using the PPLN appropriately designed depending on characteristics of an entrance light and a target emission light can perform wavelength conversion at a higher efficiency than that of soliton self-frequency shift. Using such a second-harmonic generator as the second-harmonic generator 707 enables focusing a pump light having a sufficient intensity onto the sample 726, which enables high-sensitivity measurement. However, in the case of using the PPLN, even when a configuration is employed which can change the wavelength of the Er-fiber laser light, optimization of the PPLN in the wavelength change requires a certain period of time. This makes it impossible to acquire the Raman spectrum at high speed by changing the wavelength of the Er-fiber laser light, which limits the Raman spectrum acquisition range to a wavelength range where the tunable-wavelength selective filter 712 can change the wavelength of the Yb-fiber laser light. When the Raman spectrum is to be acquired in a wide wavelength range even at low speed, an alternative configuration may be employed which enables changing the oscillation wavelength of the Er-fiber laser 705.

The second harmonic of the Er-fiber laser 705 thus acquired is used as the pump light for the SRS detection. A configuration following the second-harmonic generator 707 and a method of detecting the SRS are same as those in Embodiment 2, and therefore description thereof is omitted.

Light detectors 731 and 732 illustrated in FIG. 7 are respectively provided for detecting the Nd-fiber laser light and for detecting the second harmonic of the Er-fiber laser 705. However, when the wavelength of the Nd-fiber laser 701 is in a 900 nm band, a Si photodiode can be used as one light detector for both of the Nd-fiber laser light and the second harmonic of the Er-fiber laser 705 because the Si photodiode has detection sensitivities to both thereof.

In this embodiment, the wavelength of the first light 735 is 790 nm, 920 nm or 945 nm, and the wavelength of the second light 736 is 1030 nm. For this reason, regardless of change of the wavelength of the first light 735, the first light 735 serves as the pump light, and the second light 736 serves as the Stokes light. Therefore, a Raman spectral region increased by addition of the Er-fiber laser is as described below. When the wavelength of the Er-fiber laser light, which is the pump light, is 790 nm, the wavelength of the Yb-fiber laser light, which is the Stokes light, is 1030 nm, and a wavelength-sweep width is ±15 nm, the Raman spectral range calculated from expression (2) is a wave number range from 2806 to 3089 cm⁻¹. Since, in this Raman spectral range, expansion/contraction vibration of CH (methine) group can be observed and therefore lipid, fiber and the like that contain plenty of CH groups can be observed as well, this range is an important range in observation of biological objects. Combined use of the Er-fiber laser and the Nd-fiber laser enables observation in both the fingerprint region where a high substance identification capability can be obtained and a CH expansion/contraction vibration band where a large SRS signal can be acquired from a biological object.

This embodiment can realize an SRS microscope that uses the Er-fiber laser as the seed light source of the first light generator and thus is capable of detecting the SRS not only in the fingerprint region, but also in the CH expansion/contraction vibration band suitable for observation of biological objects.

### Embodiment 4

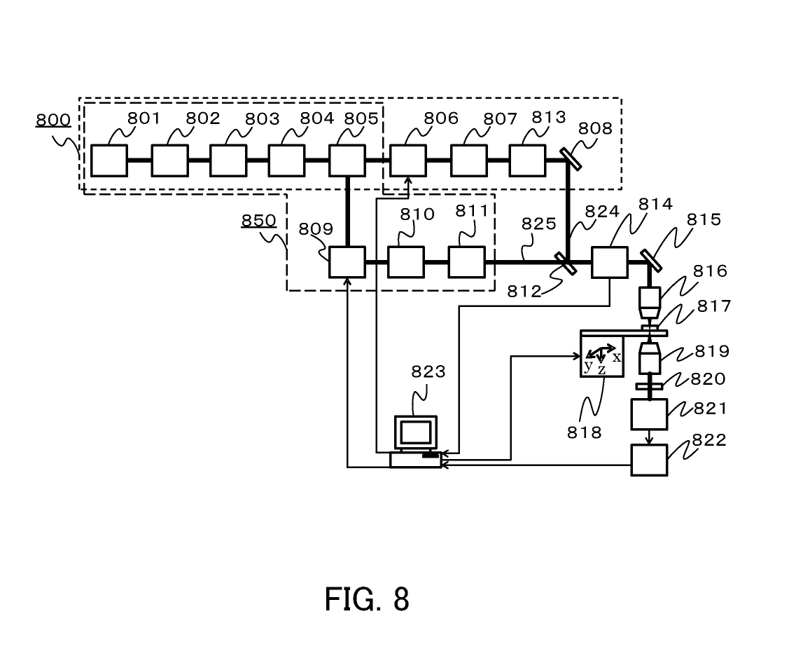

Next, referring to FIG. 8, a fourth embodiment (Embodiment 4) of the present invention will be described. In this embodiment, as light generators producing first and second lights, a single super-continuum (SC) light generator and two optical amplifiers are used. This makes it unnecessary to provide a pulse synchronizer, which enables further downsizing.

FIG. 8 illustrates a configuration of an SRS microscope of this embodiment. The SRS microscope of this embodiment includes a light focusing part and a measurement system that are approximately same as those of the SRS microscope of Embodiment 3 and is different from the SRS microscope of Embodiment 3 in that at least two optical amplifiers amplify partial wavelength bands of an SC light in gain ranges of these optical amplifiers to produce the first and second lights.

Constituent elements denoted by reference numerals 812 and 813 and 814 to 825 are identical to those denoted by reference numerals 109 and 114 and 115 to 126 in FIG. 1.

Reference numeral 800 denotes a first light generator, and 850 a second light generator. Reference numeral 801 denotes an Er-fiber laser, which is a seed light source shared by the first and second light generators 800 and 850. Reference numeral 802 denotes an Er fiber optical amplifier, and 803 an optical pulse compressor. Reference numeral 804 denotes an SC light generator, and 805 an optical splitter. Reference numerals 806 and 809 denote tunable-wavelength selective filters. Reference numeral 807 denotes a Nd-fiber optical amplifier. Reference numeral 808 denotes a mirror, and 810 a Yb-fiber optical amplifier. Reference numeral 811 denotes an intensity modulator.

Bold lines and arrowed thin lines connecting elements in the figure respectively indicate optical paths and electrical wiring lines. It is desirable that the optical paths be each formed by a fiber to an extent possible.

The Er-fiber laser 801 oscillates a light (Er-fiber laser light) whose wavelength is around 1560 nm. In order to efficiently producing the SC light at a subsequent stage, the Er-fiber laser 801 is desirable to be configured to perform a femtosecond oscillation. The Er-fiber optical amplifier 802 performs optical amplification in an oscillation wavelength band of the Er-fiber laser 801.

The optical pulse compressor 803 reduces a pulse width of the amplified Er-fiber laser light (optical pulse). Reducing the pulse width and thereby increasing a peak power of the optical pulse improves efficiency in producing the SC light. As the optical pulse compressor, a dispersion compensation fiber, a fiber bragg grating, paired diffraction gratings or the like can be used. However, when the pulse width of the Er-fiber laser 801 is narrow and thus the peak power is sufficiently large, the optical pulse compressor 803 may be omitted.

The SC light generator 804 converts the light entering from the optical pulse compressor 803 into a light having a wider wavelength bandwidth. As the SC light generator 804, a photonic crystal fiber or a highly non-linear fiber can be used. In order to improve conversion efficiency, it is desirable to use the photonic crystal fiber whose zero-dispersion wavelength is shifted to near a center wavelength of the entering light.

The optical splitter 805 splits the light from the SC light generator 804 into two lights. As the optical splitter 805, a fiber coupler or a beam splitter can be used.

The tunable-wavelength selective filters 806 and 809 respectively select mutually different wavelengths from the SC light. The tunable-wavelength selective filter 806 variably selects the wavelength in a gain band of a Nd fiber. The tunable-wavelength selective filter 809 variably selects the wavelength in a gain band of a Yb fiber. As described above, the selected wavelength width is desirable to be approximately 0.1 to 1 nm.

The Nd-fiber optical amplifier 807 and the Yb-fiber optical amplifier 810 respectively amplify powers of the selected wavelength lights lowered due to transmission through the tunable-wavelength selective filters 806 and 809. Although no amplifier can amplify an overall spectrum of the SC light having a wide wavelength bandwidth, a loss of light caused by production of the SC light can be compensated for in gain bands of the fiber optical amplifiers because the optical amplification can be sufficiently performed in the gain bands of the fiber optical amplifiers.

The intensity modulator 811 modulates an intensity of the second light 825 in order to detect an SRS signal. That is, the SRS signal is detected by lock-in detection at an intensity modulation frequency in the intensity modulator 811. As the intensity modulator 811, a pulse picker that halves a repetition frequency of an entering light can be used. Alternatively, a delay line that doubles a repetition frequency of an entering light may be inserted into an optical path in which the first light 824 is produced. In this case, the SRS signal is detected by the lock-in detection at a frequency identical to a lower one of the repetition frequencies. When the spectral focusing method is used, a chirp rate adjuster and a variable time-difference adder are inserted into one or both of the optical paths of the first light 824 and the second light 825. In this case, the tunable-wavelength selective filters 806 and 809 may be omitted.

This embodiment produces the first light 824 and the second light 825 from the shared seed light source (Er-fiber laser 801), which eliminates a pulse synchronizer and thereby enables downsizing and stabilizing the SRS microscope.

This embodiment can realize, by producing the first and second lights by using the shared light source and at least two optical amplifiers including the Nd-fiber optical amplifier, a compact stable SRS microscope capable of detecting the SRS in the fingerprint region.

### Embodiment 5

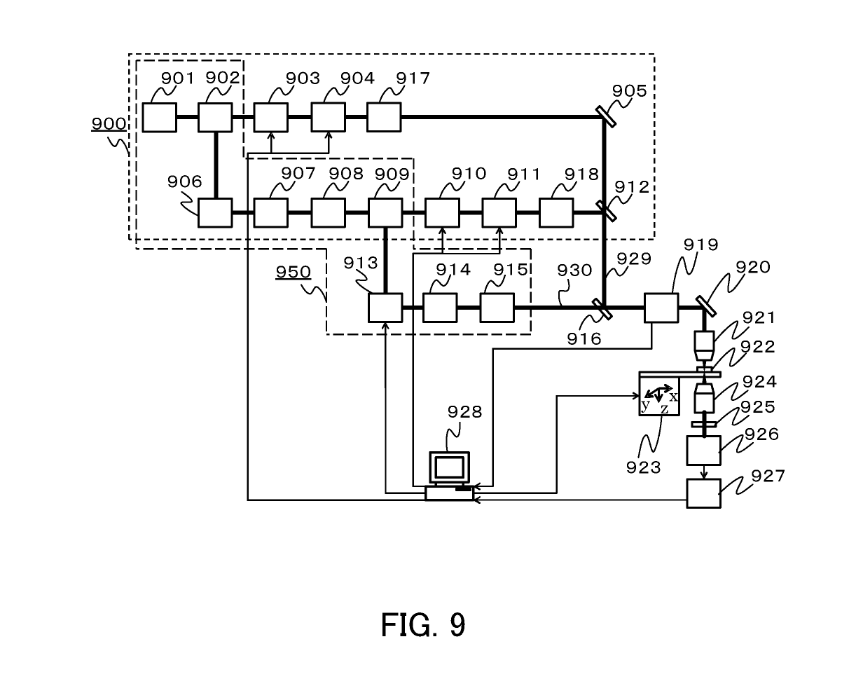

Next, referring to FIG. 9, a fifth embodiment (Embodiment 5) of the present invention will be described. This embodiment separates part of light from the seed light source in the configuration of Embodiment 4 and individually performs wavelength conversion on the separated light to focus the wavelength-converted light onto the sample, which eliminates a pulse synchronizer and enables further increase of the Raman spectrum acquisition range.

FIG. 9 illustrates a configuration of an SRS microscope of this embodiment. The SRS microscope of this embodiment includes a light focusing part and a measurement system that are approximately same as those of the SRS microscope of Embodiment 4 and is different from the SRS microscope of Embodiment 4 in that the light separated immediately after the seed light source and subjected to the wavelength conversion is focused onto the sample.

Constituent elements denoted by reference numerals 906 to 911, 913 to 916 and 919 to 930 are identical to those denoted by reference numerals 802 to 807, 809 to 812 and 814 to 825 in FIG. 8.

Reference numeral 900 denotes a first light generator, and 950 a second light generator. Reference numeral 901 denotes an Er-fiber laser, which is a seed light source shared by the first light generator 900 and a second light generator 950. Reference numeral 902 denotes an optical splitter, and 903 an Er-fiber optical amplifier. Reference numeral 904 denotes a second-harmonic generator, and 905 a mirror. Reference numerals 912 and 916 denote dichroic mirrors, and 917 and 918 denote retarding optical path adders.

Bold lines and arrowed thin lines connecting elements in the figure respectively indicate optical paths and electrical wiring lines. It is desirable that the optical paths be each formed by a fiber to an extent possible.

The Er-fiber laser 901 oscillates a light (Er-fiber laser light) whose wavelength is around 1580 nm. The optical splitter 902 splits the Er-fiber laser light into two lights. As the optical splitter 902, a fiber coupler or a beam splitter can be used. The Er-fiber optical amplifier 903 amplifies the light from the optical splitter 902 for wavelength conversion subsequently performed by the second-harmonic generator 904.

The second-harmonic generator 904 converts the light whose wavelength is near 1580 nm into a light whose wavelength is near 790 nm. The mirror 905 and the dichroic mirrors 912 and 916 are adjusted on their positions to coaxially introduce the lights to a light deflector 919.

This embodiment produces, from the shared seed light source (Er-fiber laser 901), a first light 929 and a second light 930. The first light 929 is a light composed of a light amplified by a Nd-fiber optical amplifier 911 and a light amplified by the Er-fiber optical amplifier 903. On the other hand, the second light 930 is a light amplified by a Yb-fiber optical amplifier 914. Therefore, also in this embodiment, similarly to Embodiment 4, a spectral measurement region is increased and a pulse synchronizer is eliminated, which enables downsizing, simplifying and stabilizing the SRS microscope.

This embodiment focuses the second harmonic of the Er-fiber laser light onto the sample, similarly to Embodiment 3, which enables observing not only the fingerprint region but also the expansion/contraction vibration of CH (methine) group, thereby making it possible to observe lipid, fiber and the like that contain plenty of CH groups. Furthermore, this embodiment can realize a compact stable SRS microscope that does not require a pulse synchronizer and is capable of detecting the SRS in both the fingerprint region and a region of the CH group expansion/contraction vibration (CH expansion/contraction vibration band).

This embodiment can realize, by using the Er-fiber laser as the seed light source of the first light generator, an SRS microscope capable of detecting the SRS not only in the fingerprint region but also in the CH expansion/contraction vibration band suitable for observation of biological objects.

### Embodiment 6

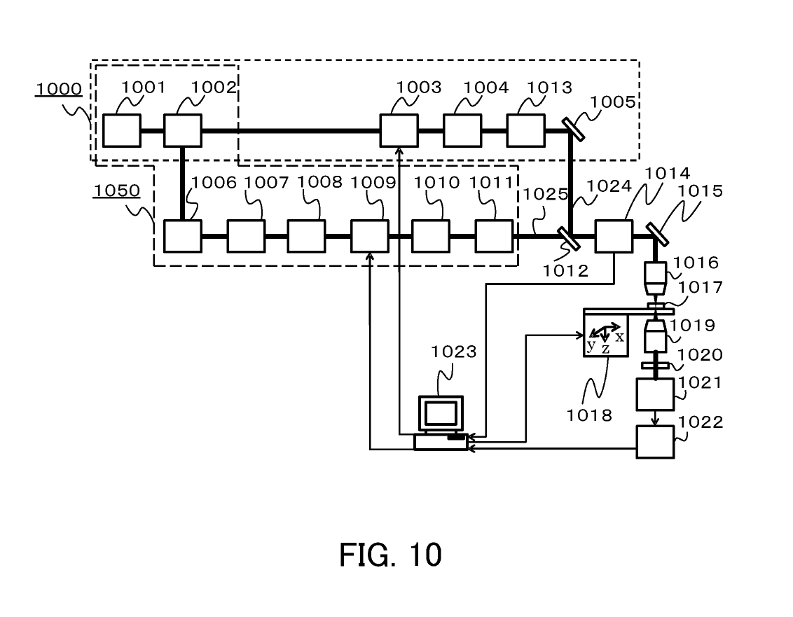

Next, referring to FIG. 10, a sixth embodiment (Embodiment 6) of the present invention will be described. This embodiment uses a Nd-fiber laser as the seed light source in the configuration of Embodiment 5, separates part of light from the seed light source, broadens a wavelength band width of the separated light and amplifies the light having a wide wavelength bandwidth by a Yb-fiber optical amplifier to focus the amplified light onto the sample, which eliminates a pulse synchronizer and enables further improvement of the signal-noise ratio.

FIG. 10 illustrates a configuration of an SRS microscope of this embodiment. The SRS microscope of this embodiment include a light focusing part and a measurement system that are approximately same as those of the SRS microscope of Embodiment 4 and is different from the SRS microscope of Embodiment 4 in that the Nd-fiber laser is used as the seed light source and in that the light separated immediately after the seed light source and subjected to the wavelength bandwidth broadening at an SC light generator is focused onto the sample.

Constituent elements denoted by reference numerals 1005 and 1009 to 1025 are identical to those denoted by reference numerals 808 and 809 to 825 in FIG. 8. Reference numeral 1000 denotes a first light generator, and 1050 a second light generator. Reference numeral 1001 denotes the Nd-fiber laser, and 1002 an optical splitter. Reference numeral 1003 denotes a tunable-wavelength selective filter. Reference numerals 1004 and 1006 denote Nd-fiber optical amplifiers. Reference numeral 1007 denotes an optical pulse compressor, and 1008 the SC light generator.

Bold lines and arrowed thin lines connecting elements in the figure respectively indicate optical paths and electrical wiring lines. It is desirable that the optical paths be each formed by a fiber to an extent possible.

The Nd-fiber laser 1001 oscillates a light (Nd-fiber laser light) whose wavelength is around 900 nm. The optical splitter 1002 splits the Nd-fiber laser light into two lights. The tunable-wavelength selective filter 1003 selects (extracts) part of the Nd-fiber laser light.

The Nd-fiber optical amplifiers 1004 and 1006 respectively amplify the split Nd-fiber laser lights. The optical compressor 1007 reduces a pulse width of the Nd-fiber laser light. The SC light generator 1008 converts the light entering from the optical compressor 1007 into a light having a wider wavelength bandwidth.

This embodiment directly amplifies the light from the seed light source (Nd-fiber laser 1001) by the subsequent optical amplifier without performing wavelength conversion or the like on the light from the seed light source in producing a first light 1024 to be used for detection of an SRS signal, which enables improvement of an SRS detection sensitivity. In addition, this embodiment produces, from the shared seed light source, the first light 1024 which is the Nd-fiber laser light and a second light 1025 which is a light amplified by the above-mentioned Yb-fiber optical amplifier 1010, which eliminates a pulse synchronizer and thereby enables downsizing, simplifying and stabilizing the SRS microscope. Moreover, this embodiment uses the seed light source emitting the light whose wavelength is around 900 nm, so that the wavelength band broadened by the SC light generator 1008 is sufficient up to 1060 nm band that is an amplification wavelength band of the Yb-fiber optical amplifier 1010. This enables suppressing a required performance of each of the Nd-fiber optical amplifier 1006 and the optical pulse compressor 1007, which consequently makes it possible to achieve a more compact system at lower cost.

In addition, although this embodiment uses the Nd-fiber laser as the seed light source, a Yb-fiber laser may be used as the seed light source. In this case, a Nd-fiber optical amplifier is used as the fiber optical amplifier subsequent to the SC light generator 1008. Moreover, depending on a power and a pulse width of the light source and on a required wavelength band, the optical pulse compressor 1007 is not necessarily required.

This embodiment enables, since wavelength conversion of the Nd-fiber laser light which is the seed light source for producing the first light is unnecessary and optical amplification of the first light and second lights can be performed, improvement of a signal-noise ratio. Furthermore, this embodiment can realize a compact stable SRS microscope that does not require a pulse synchronizer and is capable of detecting the SRS in the fingerprint region.

Each of the above-described embodiments uses the first and second light generators respectively including the Nd-doped fiber laser or the Nd-doped fiber optical amplifier and the Yb-doped fiber laser or the Yb-doped fiber optical amplifier, each of which is compact and does not cause any light power loss due to wavelength conversion, which can realize a compact SRS measurement apparatus capable of stably performing high-speed and high-sensitivity measurement in the fingerprint region.

Although each of the above embodiments has described the example configuration that measures the light transmitted through the sample, a configuration may be employed which performs measurement for a rear scattered light from the sample. Furthermore, using the configuration of each of the above embodiments enables configuring an endoscope as one application of the stimulated Raman scattering measurement apparatus (SRS observation apparatus) in which a light focusing part from which light is focused onto a sample is formed as a probe.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application Nos. 2014-010272, filed on Jan. 23, 2014 and 2014-079818, filed on Apr. 9, 2014, which are hereby incorporated by reference herein in their entirety.

What is claimed is:

1. A stimulated Raman scattering measurement apparatus comprising:
a first light generator configured to produce a first light;
a second light generator configured to produce a second light having an optical frequency different from that of the first light;
an optical system to focus the first and second lights onto a sample; and
a light detector configured to detect light whose intensity is modulated by stimulated Raman scattering generated by focusing the first and second lights onto the sample,
wherein:
the first light generator includes a Nd-doped fiber laser or a Nd-doped fiber optical amplifier, and
the second light generator includes a Yb-doped fiber laser or a Yb-doped fiber optical amplifier.

2. A stimulated Raman scattering measurement apparatus according to claim 1, wherein the first light generator includes an Er-doped fiber laser or an Er-doped fiber optical amplifier.

3. A stimulated Raman scattering measurement apparatus according to claim 2, wherein the apparatus is configured to generate the stimulated Raman scattering by using each of the first light exiting from the Nd-doped fiber laser or the Nd-doped fiber optical amplifier and the second light exiting from the Er-doped fiber laser or the Er-doped fiber optical amplifier to acquire Raman spectra.

4. A stimulated Raman scattering measurement apparatus according to claim 2, further comprising as the light detector:
a first light detector configured to detect the light whose intensity is modulated by stimulated Raman scattering generated by using the first light exiting from the Nd-doped fiber laser or the Nd-doped fiber optical amplifier; and
a second light detector configured to detect the light whose intensity is modulated by stimulated Raman scattering generated by using the second light exiting from the Er-doped fiber laser or the Er-doped fiber optical amplifier.

5. A stimulated Raman scattering measurement apparatus according to claim 1, wherein the Nd-doped fiber laser includes a changer configured to change its oscillation wavelength.

6. A stimulated Raman scattering measurement apparatus according to claim 1, wherein the Nd-doped fiber laser includes a suppressor configured to suppress a gain at a wavelength different from a wavelength of the light focused onto the sample.

7. A stimulated Raman scattering measurement apparatus according to claim 1, wherein at least one of the first and second light generators includes at least one of a fiber laser, a fiber optical amplifier and a super-continuum light source.

8. A stimulated Raman scattering measurement apparatus according to claim 1, wherein the apparatus is configured to acquire a Raman signal in a fingerprint region.

9. A stimulated Raman scattering measurement apparatus according to claim 1, wherein the first light is a first optical pulse having a first repetition frequency, and the second light is a second optical pulse having a second repetition frequency different from the first repetition frequency.

10. A stimulated Raman scattering measurement apparatus according to claim 9, wherein the first repetition frequency is higher than the second repetition frequency.

11. A stimulated Raman scattering measurement apparatus according to claim 10, wherein the first repetition frequency is an integral multiple, which is twice or more, of the second repetition frequency.

12. A stimulated Raman scattering measurement apparatus according to claim 9, wherein the light detector is configured to detect the first optical pulse whose intensity is modulated.

13. A stimulated Raman scattering measurement apparatus according to claim 12, further comprising a lock-in amplifier configured to perform, on a basis of output of the light detector, synchronous detection at the second repetition frequency.

14. A stimulated Raman scattering measurement apparatus according to claim 9, further comprising a synchronizer configured to perform synchronization control by adjusting the first or second repetition frequency so as to eliminate a relative time difference between the first and second optical pulses.

15. A stimulated Raman scattering measurement apparatus according to claim 1, further comprising a signal detector configured to detect a stimulated Raman scattering signal on a basis of output of the light detector.

16. A stimulated Raman scattering measurement apparatus according to claim 15, wherein the signal detector includes a lock-in amplifier configured to perform synchronous detection on the basis of the output of the light detector.

17. A stimulated Raman scattering measurement apparatus according to claim 16, wherein the lock-in amplifier is configured to perform the synchronous detection at the repetition frequency at which the intensity is modulated.

18. A stimulated Raman scattering measurement apparatus according to claim 1, further comprising a selector configured to extract part of the wavelength from the first or second light.

19. A stimulated Raman scattering measurement apparatus according to claim 1, further comprising:
an adjuster configured to match chirp rates of the first and second lights with each other; and
a time-difference adder configured to change a difference between times at which the first and second lights reach the sample.

20. A stimulated Raman scattering measurement apparatus according to claim 1, wherein the first and second light generators are each a polarization-maintaining fiber laser.

21. A stimulated Raman scattering measurement apparatus according to claim 1, further comprising:
an objective lens to focus the first and second lights onto the sample;
a scanner configured to two-dimensionally scan the sample with light from the objective lens;
a sample mover configured to move the sample;
a condenser lens to condense light from the sample;
a wavelength filter to transmit a light having a wavelength that is part of the wavelength of the light from the sample;
a signal detector configured to detect a stimulated Raman scattering signal from output of the light detector detecting the light transmitted through the wavelength filter; and
a processor configured to process the stimulated Raman scattering signal to output information on the sample.
